(19) United States
(12) Patent Application Publication
(10) Pub. No.: US 2023/0203724 A1
(43) Pub. Date: Jun. 29, 2023

(54) NONWOVEN BIOFABRICS

(71) Applicant: 3M INNOVATIVE PROPERTIES COMPANY, St. Paul, MN (US)

(72) Inventors: Ignatius A. Kadoma, Cottage Grove, MN (US); Jeffrey A. Chambers, St. Paul, MN (US); Michael D. Romano, Circle Pines, MN (US)

(21) Appl. No.: 18/172,454

(22) Filed: Feb. 22, 2023

Related U.S. Application Data
(63) Continuation of application No. 16/491,090, filed on Sep. 4, 2019.

(51) Int. Cl. D04H 1/407; A01G 24/00; D01D 5/098; D04H 1/413; D04H 1/435; D04H 1/56; D04H 3/011; D04H 3/16

(52) U.S. Cl. CPC D04H 1/407; A01G 24/00; D01D 5/0985; D04H 1/413; D04H 1/435; D04H 1/565; D04H 3/011; D04H 3/16

(57) ABSTRACT

A nonwoven biofabric comprises a web comprising (a) biodegradable polymeric melt blown fibers, and (b) a plurality of particles enmeshed in the biodegradable polymeric meltblown fibers.

### CROSS REFERENCE TO RELATED APPLICATIONS

This application is a continuation of U.S. Application No. 16/491,090, filed Sep. 4, 2019, now pending, which is a national stage filing under 35 U.S.C. 371 of PCT/US2018/021364, filed Mar. 7, 2018, which claims the benefit of US Provisional Patent Application No. 62/469189, filed Mar. 9, 2017, the disclosure of which is incorporated by reference in its/their entirety herein.

### FIELD

The present invention relates to nonwoven biofabrics that are useful, for example, as agricultural fabrics for controlling weed growth.

### BACKGROUND

Film such as polyethylene films are commonly used in agricultural applications such as vegetable production to control weed growth and moisture. Concerns over disposal of petroleum-based plastics, however, have some growers seeking sustainable alternatives. Bioplastic films and spunbond, nonwoven biofabrics have shown potential as mulches in vegetable production field trials. See, for example, Scientia Horticulturae 193, 209-217 (2015) and HortTechnology 26 (2), 148-155 (April 2016). Unfortunately, these biomulches can be relatively expensive.

### SUMMARY

In view of the foregoing, we recognize there is a need in the art for less expensive bio-based alternatives for controlling weed growth and moisture.

Briefly, the present invention provides nonwoven biofabrics comprising a web comprising biodegradable polymeric melt blown fibers, and a plurality of particles enmeshed in the biodegradable polymeric meltblown fibers.

The nonwoven biofabrics of the invention can be used as biomulch for controlling weed growth and moisture. The biodegradability of the nonwoven biofabrics of the invention addresses concerns about the environmental impact associated with polyethylene film mulch removal and disposal. In addition, growers can reduce the time and labor associated with removal and disposal. The inclusion of particles in the biofabrics of the invention reduces the overall cost of biofabrics. In some embodiments of the invention, the particles can provide additional benefits such as additional moisture retention, enrichment of the soil, fertilization and the like. In some embodiments of the invention, the particles can increase the overall rate of biodegradation of the biofabric.

As used herein, “biofabric” refers to fabrics made primarily from a renewable plant source.

As used herein, “web” refers to biofabrics of an open-structured entangled mass of fibers, for example, microfibers.

As used herein, “biodegradable” refers to materials or products that meet the requirements of ASTM D6400-12, which is the standard used to establish whether materials or products satisfy the requirements for labeling as “compostable in municipal and industrial composting facilities.”

As used herein, “spun bonded” refers to fabrics that are produced by depositing extruded, spun filaments onto a collecting belt in a uniform random manner followed by bonding the fibers. The fibers are separated during the web laying process by air jets or electrostatic charges.

As used herein, “meltblown” refers to making fine fibers by extruding a thermoplastic polymer through a die consisting of one or more holes. As the fibers emerge from the die, they are attenuated by an airstream.

As used herein, “particles” refers to a small piece or individual part. The particles used in embodiments of the invention can remain separate or may clump, physically intermesh, electro-statically associate or otherwise associate to form particulates.

As used herein, “enmeshed” refers to particles that are dispersed and physically held in the fibers of the web.

### BRIEF DESCRIPTION OF THE DRAWINGS

FIG. 1 is a cross-sectional view of an exemplary biofabric of the invention.

FIG. 2 is a cross-sectional view of an exemplary biofabric of the invention.

### DETAILED DESCRIPTION

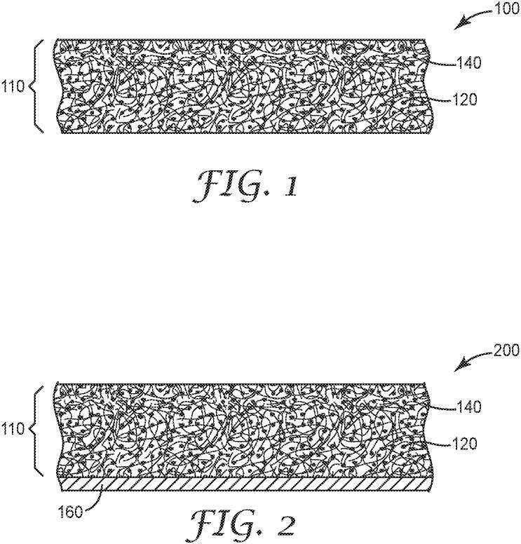

The biofabrics of the present invention comprise a particle-loaded meltblown web. As shown in FIG. 1, biofabric 100 includes a web 110 comprising biodegradable polymeric meltblown fibers 140 and a plurality of particles 120 enmeshed in biodegradable polymeric meltblown fibers 140.

The web may be formed by adding particles, particulates, and/or agglomerates or blends of the same to an airstream that attenuates polymeric meltblown fibers and conveys these fibers to a collector. The particles become enmeshed in a meltblown fibrous matrix as the fibers contact the particles in the mixed airstream and are collected to form a web. Like processes for forming particle loaded webs are disclosed, for example, in U.S. Pat. No. 7,828,969 (Eaton et al.), the disclosure of which is hereby incorporated by reference in its entirety. High loadings of particles (up to, for example, about 97% by weight) are possible according to such methods.

The particles can comprise any useful filler material. For example, the particles can comprise agricultural and forestry waste such as rice hulls, wood fiber, starch flakes, bug flour, soy meal, alfalfa meal and the like, or minerals such as gypsum, calcium carbonate and the like. In some embodiments, the particles are biodegradable. In some embodiments, the particles comprise nitrogen. Examples of useful nitrogen-containing materials include composted turkey waste, feather meal, fish meal and the like. In some embodiments, the particles are inorganic particles. For example, the particles can comprise fertilizers, lime, sand, clay, vermiculite or other related soil conditioners and pH modifiers. Preferably, the particles comprise a material that provides improved moisture retention and/or accelerates biodegradation of the biofabric and/or provides improved soil fertility. Typically, the particles are about 20 mesh to about 60 mesh, or about 25 mesh to about 35 mesh. In some embodiments, the particles are as small as about 80 mesh and as large as about 5 mesh.

The polymeric meltblown fibers comprise biodegradable materials. In some embodiments, the biodegradable meltblown fibers comprise polylactic acid (PLA), polybutylene succinate (PBS), naturally occurring zein, polycaprolactone, cellulosic esters, polyhydroxyalkanoates (PHAs) like the poly-3-hydroxybutyrate (PHB), polyhydroxyvalerate (PHV) and polyhydroxyhexanoate (PHH).

Typically, the biodegradable polymeric meltblown fibers have an average fiber diameter in a range from about 2 µm to about 50 µm, preferably in a range from about 10 µm to about 35 µm, or in a range from about 16 µm to about 26 µm. Preferably the average diameter of the particles is larger than the average diameter of the fibers for particle capture. In some embodiments, the ratio of average particle diameter to average fiber diameter is about 160:1 to about 15:1.

In some embodiments, the web has a web basis weight in a range from about 60 gsm to about 300 gsm. The biofabric needs to be sufficiently heavy for acting as a weed barrier but is preferably not too heavy for handling by farm workers or machinery. In some embodiments, the particles comprises about 1% to about 85% of the web basis weight, about 25% to about 75% of the web basis weight, or about 50% to about 60% of the web basis weight.

Particle loadings of at least 40, 50, 60, 70, 80 or even 90% are also possible. In some embodiments, loadings of about 65% to about 85%, or about 70% to about 80% are used.

In some embodiments, the biodegradable polymeric meltblown fibers comprise bicomponent fibers comprising a core material covered with a sheath wherein the sheath material (with a lower melting point) melts to bind with other fibers but the core material (with a higher melting point) maintains its shape. In other embodiments the biodegradable polymeric meltblown fibers have a homogenous structure. The homogenous structure may consist of one material or a plurality of materials evenly distributed or dispersed within the structure.

The web can be formed by methods comprising flowing molten polymer through a plurality of orifices to form filaments; attenuating the filaments into fibers; directing a stream of particles amidst the filaments or fibers; collecting the fibers and particles as a nonwoven web.

The particle loading process is an additional processing step to a standard meltblown fiber forming process, as disclosed in, for example, U.S. Pat. Publication No. 2006/0096911 (Brey et al.), incorporated herein by reference. Blown microfibers (BMF) are created by a molten polymer entering and flowing through a die, the flow being distributed across the width of the die in the die cavity and the polymer exiting the die through a series of orifices as filaments. In one embodiment, a heated air stream passes through air manifolds and an air knife assembly adjacent to the series of polymer orifices that form the die exit (tip). This heated air stream can be adjusted for both temperature and velocity to attenuate (draw) the polymer filaments down to the desired fiber diameter. The BMF fibers are conveyed in this turbulent air stream towards a rotating surface where they collect to form a web.

Desired particles are loaded into a particle hopper where they gravimetrically fill recessed cavities in a feed roll. A rigid or semi-rigid doctor blade with segmented adjustment zones forms a controlled gap against the feed roll to restrict the flow out of the hopper. The doctor blade is normally adjusted to contact the surface of the feed roll to limit particulate flow to the volume that resides in the recesses of the feed roll. The feed rate can then be controlled by adjusting the speed that the feed roll turns. A brush roll operates behind the feed roll to remove any residual particulates from the recessed cavities. The particulates fall into a chamber that can be pressurized with compressed air or other source of pressured gas. This chamber is designed to create an airstream that will convey the particles and cause the particles to mix with the meltblown fibers being attenuated and conveyed by the air stream exiting the meltblown die.

By adjusting the pressure in the forced air particulate stream, the velocity distribution of the particles is changed. When very low particle velocity is used, the particles may be diverted by the die airstream and not mix with the fibers. At low particle velocities, the particles may be captured only on the top surface of the web. As the particle velocity increases, the particles begin to more thoroughly mix with the fibers in the meltblown airstream and can form a uniform distribution in the collected web. As the particle velocity continues to increase, the particles partially pass through the meltblown airstream and are captured in the lower portion of the collected web. At even higher particle velocities, the particles can totally pass through the meltblown airstream without being captured in the collected web.

In another embodiment, the particles are sandwiched between two filament airstreams by using two generally vertical, obliquely- disposed dies that project generally opposing streams of filaments toward the collector. Meanwhile, particles pass through the hopper and into a first chute. The particles are gravity fed into the stream of filaments. The mixture of particles and fibers lands against the collector and forms a self-supporting nonwoven particle-loaded nonwoven web.

In other embodiments, the particles are provided using a vibratory feeder, eductor, or other techniques known to those skilled in the art.

For many agricultural applications, substantially uniform distribution of particles throughout the web may be advantageous so that as particles are added evenly to the soil as they compost and enrich it. Gradients through the depth or length of the web are possible, however, if desired.

The nonwoven biofabrics of the invention are effective for moisture uptake due to the tortuous porosity of the fabric combined, in some embodiments, with particles capable of moisture absorption. This attribute of the biofabrics of the invention is particularly useful to growers dependent on overhead sprinkler irrigation or rainfall to meet crop water demands.

In some embodiments the nonwoven biofabric of the invention is opaque in order to minimize light transmittance and improve weed control. The biofabric may be reflective, absorptive, light scattering or any combination thereof. For example, carbon black or titanium dioxide can be compounded into the polymeric material used to make the biofabric resulting in a black or white biofabric respectively.

In some embodiments, the nonwoven biofabric of the invention optionally comprises additives such as seeds, fertilizer, weedicide, pesticide, herbicide, and the like, and combinations thereof.

In some embodiments, such as the embodiment illustrated in FIG. 2, a biofabric 200 comprises a web 210 collected on a backing or carrier 260. Alternatively, in some embodiments, the web 210 can be sandwiched between two backings or carriers 260. The backing or carrier can provide some structure or rigidity to the biofabric as well as a means of containing loose and/or fugitive particles within the web matrix. In some embodiments, the backing or carrier is a spun bonded nonwoven. In some embodiments, the backing or carrier is paper. Preferably, the backing or carrier is biodegradable.

The nonwoven biofabrics of the invention can be provided, for example, as sheets or rolls. A roll of the biofabric may be provided on a core that can be mounted on a tractor or other laying machine for application onto the field. One application process includes laying out rolls of biofabric on the soil surface, punching holes or slits through the biofabric and planting seeds or seedlings in the holes. Crops grow through the slits or holes. For some application processes such as manual application processes, it can be preferable for the nonwoven biofabrics of the invention to be hand tearable in the cross-web direction.

### EXAMPLES

Objects and advantages of this invention are further illustrated by the following examples, but the particular materials and amounts thereof recited in these examples, as well as other conditions and details, should not be construed to unduly limit this invention.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

Raw Materials

TABLE 1

Grades of PLA resin, agricultural products and wood fibers used

| | | | | | |
|---|---|---|---|---|---|
| | Chemical Name | Supplier | Trade Designation or Description | Supplier Location | Comments |
| Extruder | Polylactic Acid | NatureWorks LLC | INGEO BIOPOLYMER 6252D | Minnetonka, MN | |
| | Polylactic Acid | NatureWorks LLC | INGEO BIOPOLYMER 6361D | Minnetonka, MN | |
| | Polylactic Acid | NatureWorks LLC | INGEO BIOPOLYMER 4032D | Minnetonka, MN | 10% Black Masterbatch |
| | Carbon Black | Clariant Corporation | BLACK PIGMENT | Minneapolis, MN | |
| | Polylactic Acid | NatureWorks LLC | INGEO BIOPOLYMER 4032D | Minnetonka, MN | 15% Black Masterbatch |
| | Carbon Black | Clariant Corporation | BLACK PIGMENT | Minneapolis, MN | |
| | Wood | American Wood Fibers | AWF MAPLE 4010 | Schofield, WI | 40 mesh |
| | Wood | American Wood Fibers | AWF MAPLE 2010 | Schofield, WI | 20 mesh |
| | Wood | American Wood Fibers | AWF MAPLE 1012 | Schofield, WI | 10 mesh |
| | Rice Hulls | Riceland Foods, Inc. | UNGROUND RICE HULLS | Stuttgart, AR | Run as supplied |
| | Rice Hulls | Riceland Foods, Inc. | UNGROUND RICE HULLS | Stuttgart, AR | Ground with 3M grinder to 40 mesh |
| Scrim | Polylactic Acid | NatureWorks LLC | INGEO BIOPOLYMER 6202D | Minnetonka, MN | Spun bond scrim, smooth calender |

TABLE 2

Agricultural fabric prototype rolls produced using Brabender extruder

| Sample Roll | Resin | Particle | Basis Weight (gsm) |
|---|---|---|---|
| - | - | - | BMF/particle/total |
| Comparative Example A | PLA 6252D | N/A | 49/0/49 |
| Example 1 | PLA 6252D | Rice Hulls | 49/91/140 |
| Example 2 | PLA 6252D | AWF 1012 | 49/255/304 |
| Example 3 | PLA 6252D | Ground Rice Hulls | 51/45/96 |
| Example 4 | PLA 6252D | AWF 2010 | 51/64/115 |
| Example 5 | 90% PLA 6252D, 9% 4032D, 1% carbon | Ground Rice Hulls | 50/46/96 |
| Example 6 | 90% PLA 6252D, 9% 4032D, 1% carbon | AWF 1012 | 50/54/104 |
| Example 7 | 90% PLA 6252D, 9% 4032D, 1% carbon | AWF 2010 | 51/64/115 |
| Example 8 | 90% PLA 6252D, 9% 4032D, 1% carbon | AWF 2010 | 51/54/105 |
| Example 9 | 70% 6252D, 30% 6361D | AWF 2010 | 54/54/108 |

### Comparative Example A

Biodegradable polylactic acid resin PLA 6252D, from NatureWorks LLC, Minnetonka, MN, was melt blown (without the addition of biodegradable particles) using the apparatus shown in FIG. 6 of U.S. Pat. Publication No. 2006/0096911 (Brey et al.) The apparatus was a Brabender twin screw extruder (Brabender® GmbH & Co. KG, Duisburg, Germany), operated at 240° C. extrusion temperature, 245° C. air temperature at 5.5 psi (38 kPa) air pressure, feed rate of 6.5 lbs/hr (2.9 kg/hour,) using a 10 inch (25.4 cm) melt blown die, and the melt blown fibers were collected at a 7.25 inch (18.4 cm) die-to-collector distance. The resulting fabric was then passed between a pair of calender rolls to flatten and bond the nonwoven fabric. The basis weight of this biodegradable agricultural fabric was 49 grams per square meter (gsm).

### Example 1

The composite agricultural fabric of Example 1 was produced as described for Comparative Example A, with the addition that unground rice hulls, obtained from Riceland Foods, Inc. (Stuttgart, AR), were provided to a gravity-fed hopper attached to the melt blowing equipment, causing the rice hulls to become entangled and captured in the molten polymer fibers as they are cooled and collected, thus forming a composite agricultural fabric. The weight ratio of polylactic acid PLA 6252D nonwoven fibers to rice hulls in the final web was 49/91, resulting in a basis weight for the nonwoven fabric, BMF/particle/total, of 49/91/140 gsm.

### Example 2

The nonwoven composite of Example 2 was produced as in Example 1 above, except that the particles used were AWF MAPLE 1012 10 mesh wood chips. The weight ratio of polylactic acid PLA 6252D nonwoven fibers to wood particles was 49/255, as shown in Table 2, resulting in a basis weight for the nonwoven fabric, BMF/particle/total, of 49/255/304 gsm.

### Example 3

The nonwoven composite of Example 3 was produced as in Example 1 above, except that the rice hulls were ground to 40 mesh size before use. The weight ratio of polylactic acid PLA 6252D nonwoven fibers to rice hull particles was 51/45, as shown in Table 2, resulting in a basis weight for the nonwoven fabric, BMF/particle/total, of 51/45/96 gsm.

### Example 4

The nonwoven composite of Example 4 was produced as in Example 1 above, except that the particles used were AWF MAPLE 2010 20 mesh wood chips. The weight ratio of polylactic acid PLA 6252D nonwoven fibers to wood particles was 51/64, as shown in Table 2, resulting in a basis weight for the nonwoven fabric, BMF/particle/total, of 51/64/115 gsm.

### Example 5

The nonwoven composite of Example 5 was produced as in Example 3 above, except that carbon black pigment was added to the resin to make the resulting fabric opaque. The carbon black was obtained from Clariant Corporation, Minneapolis, MN, and was provided as a 10% (by weight) “masterbatch” of carbon black pigment mixed in polylactic acid 4032D. The dry “masterbatch” resin was added to the PLA 6252D resin in a ratio of 10:90, so the melt stream (90% 6252D and 10% “masterbatch”) was 90% 6252D, 9% 4032D and 1% carbon black. The weight ratio of nonwoven fibers to ground rice hull particles was 50/46, as shown in Table 2, resulting in a basis weight for the nonwoven fabric, BMF/particle/total, of 50/46/96 gsm.

### Example 6

The nonwoven composite of Example 6 was produced as in Example 5 above, except that the particles used were AWF MAPLE 1012 10 mesh wood chips. The weight ratio of polylactic acid nonwoven fibers to wood particles was 50/54, as shown in Table 2, resulting in a basis weight for the nonwoven fabric, BMF/particle/total, of 50/54/104 gsm.

### Example 7

The nonwoven composite of Example 7 was produced as in Example 6 above, except that the particles used were AWF MAPLE 2010 20 mesh wood chips. The weight ratio of polylactic acid nonwoven fibers to wood particles was 51/64, as shown in Table 2, resulting in a basis weight for the nonwoven fabric, BMF/particle/total, of 51/64/115 gsm.

### Example 8

The nonwoven composite of Example 8 was produced as in Example 6 above, except that the particles used were AWF MAPLE 2010 20 mesh wood chips. The weight ratio of polylactic acid nonwoven fibers to wood particles was 51/54, as shown in Table 2, resulting in a basis weight for the nonwoven fabric, BMF/particle/total, of 51/54/105.

### Example 9

The nonwoven composite of Example 9 was produced as in Example 4 above, except that the blown melt fibers were composed of a blend of 70% biodegradable polylactic acid resin PLA 6252D, from NatureWorks LLC, and 30% polylactic acid resin 6361D, also from NatureWorks LLC. The weight ratio of polylactic acid nonwoven fibers to wood particles was 54/54, as shown in Table 2, resulting in a basis weight for the nonwoven fabric, BMF/particle/total, of 54/54/108.

### ADDITIONAL EXAMPLES

Additional examples were prepared using a single screw extruder, model 258524, made by Prodex, (GELLAINVILLE, France). Resin was fed to the extruder by a Maguire WSB-200 feeder/blender (Maguire Product, Inc., Aston, PA. The particles-wood/rice/etc. were fed by a vibratory feeder available under the trade designation MECHATRON from Schenck AccuRate (Fairfield, NJ.) In this case, the melt blown microfibers were cast onto a 30 gsm scrim of polylactic acid 6202D, obtained from NatureWorks LLC, Minnetonka, MN. The scrim was wound onto the collector and the BMF was sprayed onto the scrim on the collector. The combined roll was then taken elsewhere to calender it. The fabrics (both scrim and without-scrim constructions) were bonded with a calender (point bond and smooth rolls were used). The black pigment masterbatch obtained from Clariant Corporation for these examples consisted of 85% PLA 4032D and 15% carbon black.

Agricultural fabric prototype rolls produced using Prodex extruder

| Sample Roll | Resin | Particle | Basis Weight (gsm) |
|---|---|---|---|
| - | - | - | BMF/particle/scrim/total |
| Comparative Example B | PLA 6361D | N/A | 158/0/30/188 |
| Comparative Example C | PLA 6252D | N/A | 90/0/30/120 |
| Comparative Example D | PLA 6252D | N/A | 40/0/30/70 |
| Example 10 | 95% PLA 6252D, 4% 4032D, 0.75% carbon | AWF MAPLE 4010 | 30/41/30/101 |
| Example 11 | 95% PLA 6252D, 4% 4032D, 0.75% carbon | AWF MAPLE 4010 | 20/66/30/116 |
| Example 12 | 95% PLA 6252D, 4% 4032D, 0.75% carbon | AWF MAPLE 4010 | 20/35/30/85 |
| Example 13 | 95% PLA 6252D, 4% 4032D, 0.75% carbon | AWF MAPLE 4010 | 78/311/30/419 |
| Example 14 | 95% PLA 6252D, 4% 4032D, 0.75% carbon | AWF MAPLE 4010 | 60/151/30/241 |
| Example 15 | 95% PLA 6252D, 4% 4032D, 0.75% carbon | Rice Hulls | 30/40/30/100 |
| Example 16 | 95% PLA 6252D, 4% 4032D, 0.75% carbon | Rice Hulls | 79/208/30/317 |
| Example 17 | 95% PLA 6361D, 4% 4032D, 0.75% carbon | AWF MAPLE 4010 | 30/46/30/106 |
| Example 18 | 95% PLA 6361D, 4% 4032D, 0.75% carbon | AWF MAPLE 4010 | 20/60/30/110 |
| - | - | - | BMF/particle/scrim/total |
| Example 19 | 95% PLA 6361D, 4% 4032D, 0.75% carbon | AWF MAPLE 4010 | 79/261/30/370 |
| Example 20 | 95% PLA 6361D, 4% 4032D, 0.75% carbon | AWF MAPLE 4010 | 60/144/30/234 |
| Example 21 | 95% PLA 6361D, 4% 4032D, 0.75% carbon | AWF MAPLE 4010 | 50/192/30/272 |

### Comparative Example B

Comparative Example B consisted of only a blown melt fiber (BMF) mat of PLA 6361D (Natureworks) deposited on a 30 gsm scrim of polylactic acid 6202D, obtained from NatureWorks LLC. The blown melt fibers and scrim were bonded with a calender, as described above. The basis weight ratio was BMF/particle/scrim/total = 158/0/30/188 gsm.

### Comparative Example C

Comparative Example C was prepared in the same manner as Comparative Example B above, except that PLA 6252D (Natureworks) was used as the BMF. The basis weight ratio was BMF/particle/scrim/total = 90/0/30/120 gsm.

### Comparative Example D

Comparative Example D was prepared in the same manner as Comparative Example C above, but with a lower BMF basis weight. The basis weight ratio was BMF/particle/scrim/total = 40/0/30/70 gsm.

### Example 10

The composite agricultural fabric of Example 10 was produced as described for Comparative Example C, with the addition that 40 mesh AWF MAPLE 4010 wood particles, obtained from American Wood Fibers (Schofield, WI), were provided to a metered feeder attached to the melt blowing equipment, causing the wood particles to become entangled and captured in the molten polymer fibers as they are cooled and collected, thus forming a composite agricultural fabric. The BMF input resin was a 95:5 by weight mixture of PLA 6252D (Natureworks) and black pigment masterbatch from Clariant Corporation that consisted of 85% by weight PLA 4032D and 15% carbon black. The weight ratio of polylactic acid PLA nonwoven fibers to wood particles and scrim in the final web resulted in a basis weight for the final article of BMF/particle/scrim/total = 30/41/30/101 gsm.

### Example 11

The composite agricultural fabric of Example 11 was produced as described for Example 10 except that the basis weight was BMF/particle/scrim/total = 20/66/30/116 gsm.

### Example 12

The composite agricultural fabric of Example 12 was produced as described for Example 10 except that the basis weight was BMF/particle/scrim/total = 20/35/30/85 gsm.

### Example 13

The composite agricultural fabric of Example 13 was produced as described for Example 10 except that the basis weight was BMF/particle/scrim/total = 78/311/30/419 gsm.

### Example 14

The composite agricultural fabric of Example 14 was produced as described for Example 10 except that the basis weight was BMF/particle/scrim/total = 60/151/30/241 gsm.

### Example 15

The composite agricultural fabric of Example 15 was produced as described for Example 10 except that the particles used were rice hulls (Riceland Foods, Inc., Stuttgart, AR), and the basis weight was BMF/particle/scrim/total = 30/40/30/100 gsm.

### Example 16

The composite agricultural fabric of Example 14 was produced as described for Example 15 except that the basis weight was BMF/particle/scrim/total = 79/208/30/317 gsm.

### Example 17

The composite agricultural fabric of Example 17 was produced as described for Example 10 except that the BMF input resin was a 95:5 by weight mixture of PLA 6361D (Natureworks) and a black pigment masterbatch from Clariant Corporation that consisted of 85% by weight PLA 4032D and 15% carbon black. The basis weight of the resulting agricultural fabric was BMF/particle/scrim/total = 30/46/30/106 gsm.

### Example 18

The composite agricultural fabric of Example 18 was produced as described for Example 17 except that the basis weight was BMF/particle/scrim/total = 20/60/30/110 gsm.

### Example 19

The composite agricultural fabric of Example 19 was produced as described for Example 17 except that the basis weight was BMF/particle/scrim/total = 79/261/30/370 gsm.

### Example 20

The composite agricultural fabric of Example 20 was produced as described for Example 17 except that the basis weight was BMF/particle/scrim/total = 60/144/30/234 gsm.

### Example 21

The composite agricultural fabric of Example 21 was produced as described for Example 17 except that the basis weight was BMF/particle/scrim/total = 50/192/30/272 gsm.

### Water Uptake Test

### Procedure

A circular die measuring 5 ¼” in diameter was used to cut out circular samples. Each sample was placed in an aluminum pan measuring 18″x13″x1.25″ deep. The tray was filled with sufficient water to completely submerge the sample. The sample was then left to soak for 24 hours.

After 24 hours, each sample was removed from the water, held in a vertical position above the tray for 30 seconds to reduce water dripping from the sample, and immediately set on a weighing balance to record the new weight.

Table 4 summarizes the water uptake of each sample that was studied.

TABLE 4

Summary of moisture uptake in bio-fabric

| | TOTAL GSM | PARTICLE GSM | PARTICLE TYPE | PARITLCE % | POLYMER RESIN | Dry weight (gms) | After 24-hr soak (gms) | H₂O gained (gms) | % H2O gain |
|---|---|---|---|---|---|---|---|---|---|
| Comparative example E | | - | - | 0% | Polyethylene film | 0.48 | 0.6 | 0.12 | 25% |
| Example 22 | 101 | 41 | AWF 4010 | 41% | 95% PLA 6252D, 4.5% 4032D, 0.5% carbon | 1.36 | 8.41 | 7.05 | 518% |
| Example 23 | 101 | 51 | AWF 4010 | 50% | 95% PLA 6361, 4.5% 4032D, 0.5% carbon | 1.55 | 7.84 | 6.29 | 406% |
| Example 24 | 241 | 151 | AWF 4010 | 63% | 95% PLA 6252D, 4.5% 4032D, 0.5% carbon | 2.68 | 13.21 | 10.53 | 393% |
| Example 25 | 318 | 208 | RICE HULLS | 65% | 95% PLA 6252D, 4.5% 4032D, 0.5% carbon | 4.2 | 22.29 | 18.09 | 431% |
| Example 26 | 272 | 192 | AWF 4010 | 71% | 95% PLA 6361, 4.5% 4032D, 0.5% carbon | 3.58 | 18.4 | 14.82 | 414% |
| Example 27 | 419 | 311 | AWF 4010 | 74% | 95% PLA 6252D, 4.5% 4032D, 0.5% carbon | 3.75 | 19.23 | 15.48 | 413% |

### Comparative Example E

A black polyethylene film, sold under the Trade designation “LAWN & GARDEN MULCH FILM”, 150 Sq. Ft. by 1.5 Mil and manufactured by POLAR PLASTICS, Inc., Oakdale, MN, was purchased from a local Menards store (Eau Claire, WI).

### Example 22

Biodegradable polylactic acid resin PLA 6252D, from NatureWorks LLC, Minnetonka, MN, was melt blown using the apparatus shown in FIG. 6 of U.S. Pat. Publication No. 2006/0096911 (Brey et al.). Carbon black pigment was added to the resin to make the resulting fabric opaque. The carbon black was obtained from Clariant Corporation, Minneapolis, MN, and was provided as a 10% (by weight) “masterbatch” mixed in polylactic acid resin 4032D. The loading of the masterbatch into the melt stream was 5%, resulting in melt fibers with a composition of 95% 6252D, 4.5% 4032D and 0.5% carbon black. In addition, 40 mesh wood chips, AWF4010, obtained from American Wood Fibers, (Schofield, WI), were provided to a gravity-fed hopper attached to the melt blowing equipment, causing the wood chips to become entangled and captured in the molten polymer fibers as they are cooled and collected onto a spun bonded scrim. The scrim was manufactured using an apparatus shown in FIG. 1 of U.S. Pat. Application PCT/US2014/053640 (Berrigan et al.). The resulting agricultural fabric was then passed between a pair of smooth calendar rolls to flatten and bond the composite. The weight ratio of nonwoven fibers to wood chips in the final web was 60/41, resulting in a basis weight for the composite fabric being: nonwoven/particle/total, of 60/41/101.

### Example 23

The nonwoven composite of Example 23 was produced as in Example 22 above, except that the weight ratio of nonwoven fibers to wood chips in the final web was 50/51, resulting in a basis weight for the composite fabric being: nonwoven/particle/total, of 50/51/101.

### Example 24

The nonwoven composite of Example 24 was produced as in Example 22 above, except that the weight ratio of nonwoven fibers to wood chips in the final web was 90/151, resulting in a basis weight for the composite fabric being: nonwoven/particle/total, of 90/151/241.

### Example 25

The nonwoven composite of Example 25 was produced as in Example 22 above, except that the particles used were unground rice hulls, obtained from Riceland Foods, Inc. (Stuttgart, AR). The weight ratio of nonwoven fibers to rice hulls in the final web was 110/208, resulting in a basis weight for the composite fabric being: nonwoven/particle/total, of 110/208/318.

### Example 26

The nonwoven composite of Example 26 was produced as in Example 22 above, except that the weight ratio of nonwoven fibers to wood chips in the final web was 192/80, resulting in a basis weight for the composite fabric, nonwoven/particle/total, being equal to 80/192/272.

### Example 27

The nonwoven composite of Example 27 was produced as in Example 22 above, except that the weight ratio of nonwoven fibers to wood chips in the final web was 192/80, resulting in a basis weight for the composite fabric, nonwoven/particle/total, being equal to 108/311/419.

1. A method of controlling weed growth on a soil surface comprising the step of:
applying a web comprising a nonwoven biofabric on the soil surface to reduce light transmittance while providing moisture uptake, wherein the nonwoven biofabric comprises:
(a) biodegradable polymeric meltblown fibers compounded with carbon black or titanium dioxide; and
(b) a plurality of particles enmeshed in the biodegradable polymeric meltblown fibers, wherein the particles are selected from the group consisting of rice hulls, wood flour, starch flakes, bug flour, soy meal, alfalfa meal and combinations thereof.

2. The method of claim 1, further comprising the step of providing holes or slits in the nonwoven biofabric to enable seeds or seedlings to be planted therein.

2. The method of claim 1, wherein the biodegradable polymeric meltblown fibers comprise polylactic acid, polybutylene succinate or combinations thereof.

3. The method of claim 1, wherein the biodegradable polymeric meltblown fibers have a homogeneous structure.

4. The method of claim 1, wherein the biodegradable polymeric meltblown fibers have an average fiber diameter from 2 µm to 50 µm.

5. The method of claim 4, wherein the biodegradable polymeric meltblown fibers have an average fiber diameter from 10 µm to 35 µm.

6. The method of claim 5, wherein the biodegradable polymeric meltblown fibers have an average fiber diameter from 16 µm to 26 µm.

5. The method of claim 1, wherein the ratio of average particle diameter to average fiber diameter is from 160:1 to 15:1.

6. The method of claim 1, wherein the particles are from 20 mesh to 60 mesh.

7. The method of claim 1, wherein the web basis weight is from 60 gsm to 300 gsm.

8. The method of claim 1, wherein the nonwoven biofabric further comprises spun bonded fibers.

9. The method of claim 1, wherein the web further comprises a backing or carrier on which the nonwoven biofabric is disposed.

10. The method of claim 9, wherein the nonwoven biofabric is sandwiched between two backings or carriers.

11. The method of claim 9, wherein the backing or carrier comprises spun bonded fibers.

12. The method of claim 1, wherein the nonwoven biofabric is opaque.

13. The method of claim 1, wherein the nonwoven biofabric provides a moisture uptake of from 393% to 670% on a weight basis.

14. The method of claim 1, wherein the particles comprise from 50% to 85% of the web basis weight.

15. The method of claim 14, wherein the particles comprise from 60% to 85% of the web basis weight.

16. The method of claim 15, wherein the particles comprise from 70% to 85% of the web basis weight.

17. The method of claim 1, wherein the particles are from 20 mesh to 60 mesh.

18. The method of claim 17, wherein the particles are from 25 mesh to 35 mesh.

19. A nonwoven biofabric comprising:
(a) biodegradable polymeric meltblown fibers compounded with carbon black or titanium dioxide, and
(b) a plurality of particles enmeshed in the biodegradable polymeric meltblown fibers, wherein the particles are selected from the group consisting of rice hulls, wood flour, starch flakes, bug flour, soy meal, alfalfa meal and combinations thereof, and
further wherein the nonwoven biofabric is an agricultural fabric for weed control.

20. A nonwoven biofabric comprising:
(a) biodegradable polymeric meltblown fibers compounded with carbon black or titanium dioxide, and
(b) a plurality of particles enmeshed in the biodegradable polymeric meltblown fibers, wherein the particles comprise turkey waste, feather meal, fish meal or combinations thereof, and
further wherein the nonwoven biofabric is an agricultural fabric for weed control.
